(19) United States
(12) Patent Application Publication
(10) Pub. No.: US 2008/0302857 A1
(43) Pub. Date: Dec. 11, 2008

(54) WIRE CLAMP FOR A WIRE BONDER

(75) Inventor: Armin Felber, Luzem (CH)

Correspondence Address: MCCORMICK, PAULDING & HUBER LLP, CITY PLACE II, 185 ASYLUM STREET, HARTFORD, CT, 06103, US

(73) Assignee: OERLIKON ASSEMBLY EQUIPMENT AG, STEINHAUSEN, CHAM (CH)

(21) Appl. No.: 12/133,446

(22) Filed: Jun. 5, 2008

(30) Foreign Application Priority Data
Jun. 11, 2007 (CH) 946/07

(51) Int. Cl. B23K 37/00

(52) U.S. Cl. 228/47.1

(57) ABSTRACT

A wire clamp for a wire bonder comprises a first arm and a second arm, which is mounted on the first arm so that it is rotatable around a predetermined axis. The first arm and the second arm each have a clamping jaw on an end distal from the axis. The wire clamp also comprises a piezo bending element for opening and closing the wire clamp. One end of the piezo bending element is fastened to the second arm and an opposite end of the piezo bending element bears in a retainer fastened to the first arm.

### PRIORITY CLAIM

Applicant hereby claims foreign priority under 35 U.S.C § 119 from Swiss Application No. 946/07 filed Jun. 11, 2007, the disclosure of which is herein incorporated by reference.

### FIELD OF THE INVENTION

The invention concerns a wire clamp for a wire bonder.

### BACKGROUND OF THE INVENTION

A wire bonder is a machine for producing wire connections between a semiconductor chip and a substrate. The wire bonder contains a bonding head, which has a platform movable in a horizontal xy plane, on which a rocker rotatable around a horizontal axis is mounted. An ultrasonic transducer is fastened to the rocker, on one end of which a capillary is clamped. The rocker contains an arm running approximately parallel to the ultrasonic transducer, on which a wire clamp is fastened, which is located above the capillary. The capillary is used to fasten the wire to a connection point of the semiconductor chip and to a connection point of the substrate and to guide the wire between the two connection points. The wire is wound on a wire roll and is fed to the capillary by a wire feed device, the wire running through the wire clamp and a longitudinal drill hole of the capillary.

Such wire clamps are known from the prior art. From U.S. Pat. No. 4,653,681 a wire clamp is known, which is actuated by a linear motor, which is fastened to the end of the arm distal from the capillary. The linear motor has multiple disadvantages: it has a large moving mass, generates a large amount of waste heat, and is relatively slow. From U.S. Pat. No. 5,435,477 and U.S. Pat. No. 5,746,422 a wire clamp is known, which has a motor, constructed from multiple individual piezoelectric elements situated in series (“multilayer stack piezo motor”), and multiple film layers. The configuration of the film layers is complicated. In addition, the limited service life of such a motor is disadvantageous. From U.S. Pat. No. 5,901,896 a wire clamp is known, which is actuated by a piezoelectric bending element, which acts directly on a clamping jaw of the wire clamp. The piezoelectric bending element is a relatively heavy component which has the result in this solution that it greatly increases the moment of inertia of the rocker.

### SUMMARY OF THE INVENTION

The invention is based on the object of developing a wire clamp whose contribution to the moment of inertia of the rocker of the bonding head is as small as possible.

A wire clamp for a wire bonder comprises a first arm and a second arm, which is mounted on the first arm so that it is rotatable around a predetermined axis. The first arm and the second arm have a clamping jaw on an end distal from the axis. The wire clamp further comprises a piezo bending element for opening and closing the wire clamp. One end of the piezo bending element is fastened to the movable arm and an opposite end of the piezo bending element bears in a retainer fastened to the first arm. The position of the retainer is advantageously adjustable, so that the spacing between the clamping jaws to be assumed in the open state of the wire clamp may be set. A mechanical or electrical damper is advantageously provided to suppress or at least reduce oscillations upon closing of the wire clamp.

### BRIEF DESCRIPTION OF THE DRAWING FIGURES

The accompanying drawings, which are incorporated into and constitute a part of this specification, illustrate one or more embodiments of the present invention and, together with the detailed description, serve to explain the principles and implementations of the invention. The figures are schematic and are not to scale. In the drawings:

FIG. 1 shows a top view of a wire clamp according to the invention in the open state, and

FIG. 2 shows a side view of the rocker of the bonding head of a wire bonder which is equipped with the wire clamp according to the invention.

### DETAILED DESCRIPTION OF THE PREFERRED EMBODIMENTS

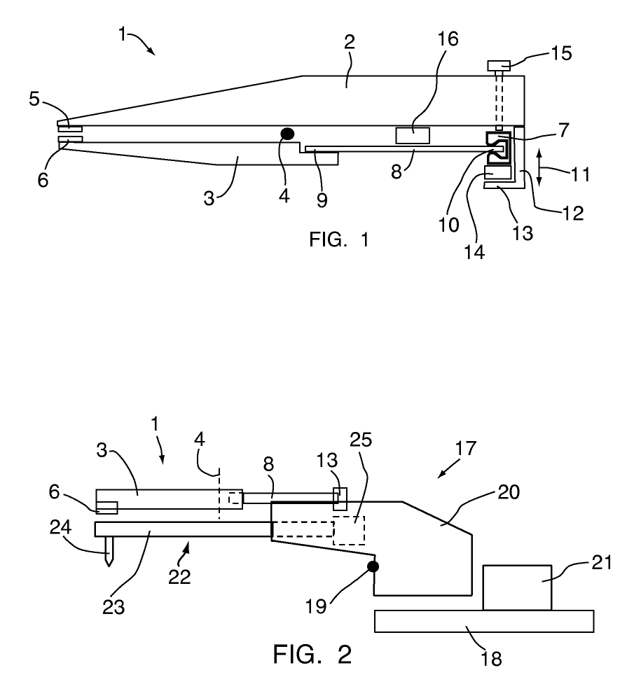

FIG. 1 shows a top view of a wire clamp 1 according to the invention in the open state. The wire clamp 1 comprises a first arm 2, which is fastened to the rocker of the bonding head of a wire bonder, and a second arm 3, which is movable in relation to the first arm 2: The second arm 3 is mounted on the first arm 2 so that it is rotatable around an axis 4 running perpendicular to the plane of the drawing. A clamping jaw 5 or 6 is fastened on each of the arms 2 and 3 at an end distal from the axis 4. A retainer 7 is arranged on the first arm 2 on its end opposite to the end with the clamping jaw 5. The retainer 7 preferably consists of plastic. The operation of the wire clamp 1 is performed using a piezo bending element 8, one end 9 of which is fastened to the second, movable arm 3, and the other end 10 of which bears in the retainer 7.

The retainer 7 is fastened to the first arm 2 in such a manner that it is displaceable in a direction illustrated by an arrow 11. A simple solution is shown in FIG. 1. An angle having two arms 12 and 13 is fastened to the first arm 2. A part 14 made of elastic material, for example, rubber, is glued to the arm 13. The retainer 7 is located between the first arm 2 of the wire clamp 1 and the part 14 made of elastic material. A screw 15 mounted in a thread introduced into the first arm 2 presses the retainer 7 against the part 14 made of elastic material. The retainer 7 is clamped between the screw 15 and the part 14 made of elastic material. By rotating the screw 15, the position of the retainer 7 may be displaced in the direction 11 and thus the distance between the two clamping jaws 5 and 6 in the open state may be adjusted.

FIG. 2 schematically shows a lateral view of the bonding head 17 of a wire bonder. The bonding head 17 comprises a platform 18 movable in a horizontal plane, on which a rocker 20 rotatable around a horizontally running rotational axis 19 and a motor 21 for rotating the rocker 20 around the rotational axis 19 are positioned. An ultrasonic transducer 22 is fastened to the rocker 20. The ultrasonic transducer 22 comprises a horn 23, on one end of which a capillary 24 is clamped, and at least one piezoelectric drive 25, to excite the ultrasonic transducer 22 into ultrasonic oscillations. In FIG. 2 the second arm 3 of the wire clamp 1 having its clamping jaw 6, the piezo bending element 8 and the arm 13 of the angle are visible. The first arm 2 is located behind the second arm 3 and was left out for clarity of the drawing.

The solution with this wire clamp offers the following advantages:
The piezo bending element 8 is located in proximity to the end of the wire clamp 1 distal from the clamping jaws 5 and 6, and thus relatively close to the rotational axis 19 of the rocker 20. The contribution of the wire clamp 1 according to the invention to the moment of inertia of the rocker 20 is thus much less than in the solution according to U.S. Pat. No. 5,901,896, which allows greater accelerations of the rocker 20 at smaller bearing forces.
The clamping jaws 5 and 6, which are manufactured from special material, may be fastened in a conventional manner to the arms 2 and 3. In particular, neither of the clamping jaws 5 and 6 has to be fastened directly to the piezo bending element 8, which is difficult.
The service life of the piezo bending element 8 is significantly longer than the service life of a “multilayer stack piezo” motor.
The time for opening or closing the wire clamp 1 is typically less than 1 ms (millisecond).

The piezo bending element 8 of the wire clamp 1 has three electrodes. In operation, a constant voltage V₁ or V₂ is applied to the two external electrodes, for example, V₁=0 V and V₂=450 V. A variable voltage V₃ is applied to the middle electrode, which is between the voltages V₁ and V₂. If the voltage V₃ is greater than the voltage ½ (V₂−V₁), the piezo bending element 8 is curved to one side in such a manner that the wire clamp 1 is closed. If the voltage V₃ is less than the voltage ½ (V₂−V₁), the piezo bending element 8 is curved to the other side, so that the wire clamp 1 is opened. The curvature of the piezo bending element 8 is not perceptible to the human eye. The force exerted by the two clamping jaws 5 and 6 (FIG. 1) on the wire is proportional to the difference V₃−½ (V₂−V₁). Because the piezo bending element 8 is curved to one side or the other in operation, the bearing point of the piezo bending element 8 in the retainer 7 shifts, though only by a distance in the magnitude of a micrometer.

To suppress undesired oscillations of the mobile arm 3 of the wire clamp 1 upon closing or at least reduce them to an acceptable amount, it is advantageous to provide mechanical or electrical damping. To achieve mechanical damping, a damping element, namely a part 16 (FIG. 1) made of elastic material such as Rubasorb, is clamped between the piezo bending element 8 and the first arm 2, advantageously in the area of the antinode of the piezo oscillation. Alternatively, electrical damping of the piezo bending element 8 is possible, in which the electrical circuit for controlling the piezo bending element 8 recognizes oscillation tendencies by measuring the voltage applied to the piezo bending element 8 and/or the current flowing through the piezo bending element 8 and actively damps them.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims and their equivalents.

What is claimed is:

1. A wire clamp for a wire bonder, comprising
a first arm,
a second arm mounted rotatably around a predetermined axis on the first arm, the first arm and the second arm each having a clamping jaw on an end distal from said axis,
a retainer situated on the first arm, and
a piezo bending element for opening and closing the wire clamp, one end of the piezo bending element fastened to the second arm and an opposite end of the piezo bending element bearing in said retainer.

2. The wire clamp according to claim 1, wherein the position of the retainer is adjustable.

3. The wire clamp according to claim 1, further comprising a part made of elastic material clamped between the piezo bending element and the first arm.

4. The wire clamp according to claim 2, further comprising a part made of elastic material clamped between the piezo bending element and the first arm.
